(19) United States
(12) Patent Application Publication
(10) Pub. No.: US 2019/0160463 A1
(43) Pub. Date: May 30, 2019

(54) PARTICLE MANIPULATION

(71) Applicant: SINGAPORE UNIVERSITY OF TECHNOLOGY AND DESIGN, Singapore (SG)

(72) Inventors: Ye Ai, Singapore (SG); Zhichao Ma, Singapore (SG)

(21) Appl. No.: 16/091,813

(22) PCT Filed: Jul. 19, 2017
(86) PCT No.: PCT/SG2017/050192

§ 371 Date: Oct. 5, 2018

(30) Foreign Application Priority Data
Apr. 6, 2016 (SG) 10201602719V

(51) Int. Cl. B01L 3/00

(52) U.S. Cl. CPC B01L 3/502761; B01L 2200/0652; B01L 2300/0816; B01L 2400/0439; B01L 2300/12; B01L 2300/0832; B01L 2400/0436

(57) ABSTRACT

The present invention relates to the manipulation and, more particularly, to the sorting of particles. Still more particularly, the present invention relates to the use of acoustic waves, including surface acoustic waves, for the manipulation and sorting of particles. In an example, the present invention may be used for the sorting of cells. In an aspect of the invention, there is provided a device for manipulating a particle in a fluid suspension, the device comprising: (a) a substrate having a surface; (b) an acoustic source configured to generate and deliver an acoustic wave within a region of the substrate surface; and (c) a pillar disposed on the surface of the substrate and the pillar is configured to receive a channel, the channel configured to receive the fluid suspension, wherein the acoustic wave delivered within the region of the substrate surface is delivered to the fluid suspension in the channel through the pillar. A method using the device of the invention is also disclosed.

The present invention relates to the manipulation and, more particularly, to the sorting of particles. Still more particularly, the present invention relates to the use of acoustic waves, including surface acoustic waves, for the manipulation and sorting of particles. In an example, the present invention may be used for the sorting of cells.

Separation of microscopic particles and droplets is an essential technique for various biological research and medical applications. For example, separation and enrichment of low concentration microbes from complex biological samples is of great importance for accurate and rapid medical diagnosis. In recent years, the rapidly growing field of cell therapy also has a high demand in simple and efficient cell separation techniques that can speed up the collection of desired stem cells from complex samples.¹ Microfluidics enables precise manipulation of biological cells, and has been innovating diverse approaches for particle separation, such as dielectrophoresis,^{2, 3} inertial focusing,^{4, 5} magnetophoresis,^{6, 7} optical tweezing^{8, 9} and acoustophoresis.¹⁰ Among these techniques, acoustophoresis has been widely exploited to manipulate cells and particles thanks to its low power consumption and good biocompatibility. The acoustic radiation pressure exerts on particles suspended in fluids when they are exposed to an acoustic wave.¹¹ The correlation of the acoustic radiation force with size, density and compressibility of the particles enables selective separation of particles according to their physical properties,¹²⁻¹⁴ which offers a biocompatible and label-free separation approach for various biomedical applications.

Two major types of acoustic wave, bulk acoustic wave (BAW) and surface acoustic wave (SAW), have been used for particle manipulation in microfluidics. The BAW-based acoustofluidic device is typically built by irreversibly bonding piezoelectric ceramics (e.g. lead zirconate titanate) onto microfluidic channels made of silicon or glass with good acoustic reflection property.^{15, 16} Compared to the BAW-based acoustofluidics, the use of SAW transducer offers several advantages. First, the SAW transducer is compatible with soft polymer materials that have been widely used to fabricate low cost microfluidic devices. Second, the SAW transducer is fabricated by depositing interdigital electrodes (IDE or IDT) on a piezoelectric substrate. Its resonance frequency is determined based on the dimensions of these electrodes, which could easily produce high frequency acoustic wave up to GHz,¹⁷ however unachievable using BAW transducers. The use of high frequency SAW enables manipulation of micron-sized particles via a travelling acoustic field rather than a standing acoustic field employed in conventional acoustofluidic devices.¹⁸⁻²⁰. Compared to the displacement limit of one quarter of the wavelength in a standing field,²¹⁻²⁴ there is no inherent limit in the particle displacement driven by a travelling SAW (TSAW), which is an advantage of separation using TSAW.

In practical biomedical applications, especially when dealing with bio-hazardous materials, it is highly desired to discard components that have direct contact with biological samples after use. Ideally, the microfluidic channel devices for biological sample loading are disposable for a single use to avoid cross-contamination between different samples; while the more expensive and sophisticated actuators for sample processing are reusable. However, in most of the current SAW-based acoustofluidic systems, the microfluidic channel devices are still irreversibly bonded onto the SAW transducers.^{13, 20, 25-27} The whole acoustofluidic system including both the channel device and SAW transducer is relatively expensive so that it cannot be afforded for single use.

The listing or discussion of an apparently prior-published document in this specification should not necessarily be taken as an acknowledgement that the document is part of the state of the art or is common general knowledge.

Any document referred to herein is hereby incorporated by reference in its entirety.

The present invention relates to an improved method and device for particle sorting, manipulation, and characterization that would be useful for numerous applications. In an embodiment, the present invention includes the concentration, focusing, and/or characterisation of particles such as cells and/or microorganisms.

In particular, the present invention is an detachable microfluidic apparatus for manipulating particles using surface acoustic waves (SAWs). This microfluidic apparatus includes a disposable microfluidic channel device and a reusable SAW transducer device. The channel device, used for particle sample loading, can be reversibly attached onto the SAW transducer via micron-sized pillar on the bottom of the channel device. The SAWs radiated into the upper channel device via the pillar can manipulate the flow-through particles in a noncontact manner. Once the manipulation of the introduced sample is complete, the channel device can be directly detached from the SAW transducer and discarded without washing process.

Components in biomedical analysis tools that have direct contact with biological samples especially bio-hazardous materials are ideally to be discarded after use for preventing cross-contamination. Conventional acoustofluidic device is typically a monolithic integration that permanently bonds acoustic transducers with microfluidic channels, which however cannot be afforded for single use. Here, we demonstrate a detachable acoustofluidic system consisting of a disposable channel device and a reusable acoustic transducer for non-contact particle manipulation via a single travelling surface acoustic wave (TSAW). The channel device can be placed onto the SAW transducer using naked eyes with a high tolerance in alignment, which largely simplifies the system operation. A micro-structured pillar slightly large than the channel area beneath the channel device is in direct contact with the bottom SAW transducer to guide the wave propagation into the fluid channel for particle manipulation. We have demonstrated the separation of 10 μm and 15 μm particles at high separation efficiency above 98% in a 49.5 MHz TSAW using the developed detachable acoustofluidic system. Its disposability and ease of assembly could enable a broad use of the developed non-contact particle manipulation technique in practical biomedical applications related to sample preparation.

In a first aspect of the present invention, there is provided a device for manipulating a particle in a fluid suspension, the device comprising: (a) a substrate having a surface; (b) an acoustic source configured to generate and deliver an acoustic wave within a region of the substrate surface; and (c) the surface of the substrate is configured to receive a pillar and the pillar is configured to receive a channel, the channel configured to receive the fluid suspension, wherein the acoustic wave delivered within the region of the substrate surface is delivered to the fluid suspension in the channel through the pillar.

In a second aspect of the present invention, there is provided device for manipulating a particle in a fluid suspension, the device comprising: (a) a substrate having a surface; (b) an acoustic source configured to generate and deliver an acoustic wave within a region of the substrate surface; (c) a channel configured to receive the fluid suspension; and (d) a pillar disposed between the surface of the substrate and the channel, wherein the acoustic wave delivered within the region of the substrate surface is delivered to the fluid suspension in the channel through the pillar.

Advantageously, acoustic waves transmitted into the channel through the substrate and pillar are at least sufficient to affect the fluid suspension within the channel, and in some embodiments such that sorting of particles or other species in the fluid suspension is able to occur. In one set of embodiments, there may be three, four, five, or more outlet channels, and in some embodiments the sorting of particles into the two or more outlet channels may be controlled by controlling the surface acoustic waves, e.g., by applying suitable voltages to the piezoelectric substrate. Advantageously, the pillar acts as a waveguide to localise the acoustic field in the liquids for particle manipulation.

By “pillar”, it is meant to refer to any suitable support member or structure or post intermediate the substrate and the channel that supports or hold up the channel. In this specification, the words “pillar” and “micro-pillar” may be used interchangeably. Preferably, the pillar may be a vertical support or column. Preferably, the pillar is configured to be detachably attached to the surface of the substrate.

By “detachably attached”, it is meant to refer to any bonding between the pillar and the channel that may be easily removed. The attachment or adhesion may be carried out by any suitable technique known to the skilled person. Any acoustic coupling gel (e.g. the gel used for ultrasound imaging) may be used to enhance the wave transmission at the interface between the pillar and the channel, and the fluid suspension.

Advantageously, the device of the present invention allows a user to reuse the particle manipulation device without having to dispose the substrate and the acoustic source. In particular, the acoustic source and the substrate is reuseable. The pillar of the present invention may either be fabricated on the surface of the substrate or on the bottom of a channel or channel device, i.e. the pillar may be detachably attached to either the surface of the substrate or the channel. Fabrication of the pillar on the surface of the piezoelectric substrate or on the bottom of the channel as part of a channel device may be carried out by using any photolithography or 3D printing techniques or any other suitable techniques.

In the embodiment where the pillar is detachably attached to the channel device, the reuseable part of the device may be the substrate, which includes the substrate comprising the pillar and the acoustic source in the form of a SAW transducer. Any channel or channel device for receiving a fluid suspension may then be detachably attached to the pillar for carrying out the particle manipulation method. Once the method has been carried out, the channel or channel device is removed and disposed, leaving behind the substrate (comprising the pillar and the acoustic source) for use with another fresh particle manipulation method. A fresh or new channel device may then be used for the next particle manipulation/sorting exercise by detachably attaching or adhering a new channel to the pillar associated with the substrate and the SAW transducer.

In the alternative embodiment where the pillar is fabricated with the channel, the reuseable part of the device is the substrate comprising the substrate and the acoustic source. The substrate is configured then to receive the pillar which is attached to the channel. After use, the pillar with the channel is detachably removed from the surface of the substrate and the pillar with the channel is disposed. A fresh channel with a pillar may then be attached to the surface of the substrate for carrying out another particle manipulation method.

Preferably, the pillar forms a wall or part of a wall of the channel.

Preferably, the pillar is made of a material suitable for conducting an acoustic wave, i.e. any suitable material that has good acoustic transmission properties. Preferably, the material is any one selected from the group comprising: glass, polymethylmethacrylate (PMMA), and polycarbonate (PC). In an embodiment, the pillar and channel are made of the same material.

Preferably, the width of the pillar is between 5 μm to 500 μm.

In an embodiment, the device comprises a plurality of pillars that are equally spaced apart. Alternatively, the plurality of pillars may be arranged in any arbitrary pattern.

Preferably, the substrate is a piezoelectric substrate. The piezoelectric substrate is any piezoelectric material selected from the group comprising: lithium niobate, lithium tantalite, and lanthanum gallium silicate.

Preferably, the acoustic source is an interdigital transducer and the acoustic wave may be a single travelling surface acoustic wave or a combination of multiple travelling surface acoustic waves.

Any suitable technique may be used to create the travelling surface acoustic wave. For example, the surface acoustic wave may be created by a generator attached to the surface of the microfluidic channel. In certain embodiments, the surface acoustic wave is created by using an interdigitated electrode or transducer able to convert electrical signals into acoustic wave able to travel along the surface of the substrate, and in some cases, the frequency of the surface acoustic wave may be controlled by controlling the spacing of the finger repeat distance of the interdigitated electrode or transducer.

By “interdigital transducer (IDT)” or “interdigital electrode (IDE)”, it is meant to refer to any one, two, or more electrodes containing a plurality of “fingers” extending away from the electrode, wherein at least some of the fingers are interdigitated. In an embodiment, particularly when the piezoelectric substrate is lithium niobate, there are about 20 to 100 finger pairs in the electrode. The fingers may be of any length, and may independently have the same or different lengths. The fingers may be spaced on the transducer regularly or irregularly. In some cases, the fingers may be substantially parallel, although in other embodiments they need not be substantially parallel. In an embodiment, the present IDT comprises a plurality of concentric circular arcs having a tapered end that is directed towards the microfluidic channel. The tapered end forms the beam aperture. The angle subtended at the center of the concentric circular arcs of the IDT may be about 5 to 90 degrees. Preferably, in an embodiment, the angle is about 26 degrees.

The IDT may be supplied with any suitable AC supply known to the skilled person. The acoustic energy is maximized at the resonance frequency that is determined by the dimensions of the electrode fingers, size and spacing.

The surface acoustic waves can be formed on a piezoelectric substrate or other material that may be coupled to a microfluidic substrate at specific locations, e.g., at locations within the microfluidic substrate where sorting is to take place. Suitable voltages (e.g., sinusoidal or other periodically varying voltages) are applied to the piezoelectric substrate, which converts the electrical signals into mechanical vibrations, i.e., surface acoustic waves or sound. The sound is then coupled to the microfluidic substrate, e.g., from the surface of the material. In the microfluidic substrate, the vibrations pass into liquid within microfluidic channels in the microfluidic substrate, which give rise to internal streaming within the fluid and acoustic radiation that directly exerts a force on particles exposed to the acoustic field. Thus, by controlling the applied voltage, streaming within the microfluidic channel, as well as the acoustic radiation force on particles, may be controlled, which may be used to direct or sort particles within the microfluidic channel, e.g., to particular regions within the microfluidic substrate. The travelling surface acoustic wave may induce two acoustic effects—an acoustic streaming and an acoustic radiation. In addition to acoustic radiation, acoustic streaming may also be dominant if a suitable power is supplied to the IDT in the microfluidic device. Advantageously, acoustic streaming may also provide useful cell manipulation capability to the microfluidic device.

Advantageously, the present invention requires only one IDT to generate the travelling surface acoustic wave placed adjacent the microfluidic channel to deliver the wave transverse the flow of the fluid suspension in the channel.

The piezoelectric substrate may be activated by any suitable electronic input signal or voltage to the piezoelectric substrate (or portion thereof). For example, the input signal may be one in which a periodically varying signal is used, e.g., to create corresponding acoustic waves. For instance, the signals may be sine waves, square waves, sawtooth waves, triangular waves, or the like. The frequency may be for example, between about 50 Hz and about 100 KHz, between about 100 Hz and about 2 kHz, between about 100 Hz and about 1,000 Hz, between about 1,000 Hz and about 10,000 Hz, between about 10,000 Hz and about 100,000 Hz, or the like, and/or combinations thereof. In some cases, the frequency may be at least about 50 Hz, at least about 100 Hz, at least about 300 Hz, at least about 1,000 Hz, at least about 3,000 Hz, at least about 10,000 Hz, at least about 30,000 Hz, at least about 100,000 Hz, at least about 300,000 Hz, at least about 1 MHz, at least about 3 MHz, at least about 1.0 MHz, at least about 30 MHz, at least about 100 MHz, at least about 300 MHz, or at least about 1 GHz or more in some embodiments. In certain instances, the frequency may be no more than about 1 GHz, no more than about 300 MHz, no more than about 100 MHz, no more than about 30 MHz, no more than about 10 MHz, no more than about 3 MHz, no more than about 1 MHz, no more than about 300,000 Hz, no more than about 100,000 Hz, no more than about 30,000 Hz, no more than about 10,000 Hz, no more than about 3,000 Hz, no more than about 1,000 Hz, no more than about 300 Hz, no more than about 100 Hz, or the like. In a preferred embodiment, the frequency of the travelling surface acoustic wave is greater than 50 MHz.

Preferably, the surface acoustic wave of the present invention has an average frequency of between 1 MHz and 1000 MHz. More preferably, the frequency is above 50 MHz to effectively manipulate particles on the order of a few microns. The frequency may vary during use of the microfluidic device. In particular, the spacing between adjacent electrode fingers can gradually change to have a wider working frequency range.

The IDT may be positioned on the piezoelectric substrate (or other suitable material) such that acoustic waves produced by the IDT are directed at a region of acoustic coupling between the piezoelectric substrate and the microfluidic channel. This region may also be referred to as the sorting/manipulation region.

In an embodiment, the IDT and the microfluidic channel shares the same substrate. The IDT is fabricated by depositing metallic electrodes on the piezoelectric substrate; the microfluidic channel may be an open layer with concave channel. By bonding this open layer onto the piezoelectric substrate, it can close the open channel and form a closed microfluidic channel. As the acoustic beam may not have uniform width along the wave propagation. So the distance from the IDT to the channel is also critical to ensure a highly confined sound beam in the channel region.

The channel, or channel device, may be made from any suitable material. The channel and the pillar and the substrate may be made from the same material, or the material for each component may be different. For example, the channel may be made from PDMS. Preferably, the channel is a microchannel having a cross-sectional diameter of less than 1 mm. The cross-section of the channel may be a rectangle. Preferably, the channel having at least one inlet for receiving the fluid suspension and at least one outlet for discharging the fluid suspension. In alternative embodiments, there may be any suitable number of inlets and outlets. The channel or channel device may be supported by any means (e.g. support structures) on the substrate and/or the pillar.

By “channel”, it is meant to refer to any feature on or in (or defined) in the substrate that at least partially directs flow of the fluid. The channel can have any cross-sectional shape (circular, oval, triangular, irregular, square or rectangular, or the like) and can be covered or uncovered. In embodiments where it is completely covered, at least one portion of the channel can have a cross-section that is completely enclosed, or the entire channel may be completely enclosed along its entire length with the exception of its inlet(s) and/or outlet(s). A channel may also have an aspect ratio (length to average cross sectional dimension) of at least 2:1, more typically at least 3:1, 5:1, 10:1, 15:1, 20:1, or more. An open channel generally will include characteristics that facilitate control over fluid transport, e.g., structural characteristics (an elongated indentation) and/or physical or chemical characteristics (hydrophobicity vs. hydrophilicity) or other characteristics that can exert a force (e.g., a containing force) on a fluid. The fluid within the channel may partially or completely fill the channel. In some cases where an open channel is used, the fluid may be held within the channel, for example, using surface tension (i.e., a concave or convex meniscus). By “channel device”, it is meant to include any device comprising the channel. It also includes, the channel itself comprising any inlets and outlets. In the present invention, the terms “channel” and “microfluidic channel” may be used interchangeably.

The channel may be of any size, for example, having a largest dimension perpendicular to fluid flow of less than about 5 mm or 2 mm, or less than about 1 mm, or less than about 500 microns, less than about 200 microns, less than about 100 microns, less than about 60 microns, less than about 50 microns, less than about 40 microns, less than about 30 microns, less than about 25 microns, less than about 10 microns, less than about 3 microns, less than about 1 micron, less than about 300 nm, less than about 100 nm, less than about 30 nm, or less than about 10 nm. In a preferred embodiment, the width of the microfluidic channel is about between 10 μm and 1000 μm, and the height of the channel is about 1 μm to 100 μm. In some cases the dimensions of the channel may be chosen such that fluid is able to freely flow through the article or substrate. The dimensions of the channel may also be chosen, for example, to allow a certain volumetric or linear flowrate of fluid in the channel. Of course, the number of channels and the shape of the channels can be varied by any method known to those of ordinary skill in the art. In some cases, more than one channel or capillary may be used. For example, two or more channels may be used, where they are positioned inside each other, positioned adjacent to each other, positioned to intersect with each other, etc.

The wall of the microfluidic channel wall may be of any thickness. In order to minimize the sound attenuation, the channel wall in contact with the pillar should be as thin as possible. The wall may be as thin as 5 μm to 100 μm. This wall thickness refers to the thickness of the material that separates the fluid confined in the channel from the air. Ideally, this wall should be as thin as possible to minimize the wave attenuation. In reality, this wall thickness is from 5-100 um, considering the wave attenuation, fabrication feasibility, and sealability of the channel.

Preferably, the particle is less than 50 μm in size.

Preferably, the particle is any particle selected from the group: organic particles, inorganic particles, biological cells, and microorganisms. The cells may either be labelled or not prior to sorting/manipulation.

By “cell”, it is meant to refer to its ordinary meaning as used in biology. The cell may be any cell or cell type. For example, the cell may be a bacterium or other single-cell organism, a plant cell, or an animal cell. If the cell is a single-cell organism, then the cell may be, for example, a protozoan, a trypanosome, an amoeba, a yeast cell, algae, etc. If the cell is an animal cell, the cell may be, for example, an invertebrate cell (e.g., a cell from a fruit fly), a fish cell (e.g., a zebrafish cell), an amphibian cell (e.g., a frog cell), a reptile cell, a bird cell, or a mammalian cell such as a primate cell, a bovine cell, a horse cell, a porcine cell, a goat cell, a dog cell, a cat cell, or a cell from a rodent such as a rat or a mouse. If the cell is from a multicellular organism, the cell may be from any part of the organism. For instance, if the cell is from an animal, the cell may be a cardiac cell, a fibroblast, a keratinocyte, a heptaocyte, a chondracyte, a neural cell, a osteocyte, a muscle cell, a blood cell, an endothelial cell, an immune cell (e.g., a T-cell, a B-cell, a macrophage, a neutrophil, a basophil, a mast cell, an eosinophil), a stem cell, etc. In some cases, the cell may be a genetically engineered cell. In certain embodiments, the cell may be a Chinese hamster ovarian (“CHO”) cell or a 3T3 cell.

In a third aspect of the present invention, there is provided a method for manipulating a particle in a fluid suspension, the method comprising: (a) providing a substrate having a surface; (b) providing an acoustic source; (c) providing a pillar disposed on the surface of the substrate, the pillar configured to receive a channel and the channel configured to receive the fluid suspension; and (d) manipulating the particle in the channel by using the acoustic source to generate and deliver an acoustic wave to the fluid suspension in the channel through the substrate and pillar.

Preferably, the pillar is configured to be detachably attached to the surface of the substrate.

Preferably, the pillar forms a wall or part of a wall of the channel.

Preferably, the pillar is made of a material suitable for conducting an acoustic wave. In an embodiment, the pillar is made of a material that is any one selected from the group comprising: glass, polymethylmethacrylate (PMMA), and polycarbonate (PC). In an embodiment, the pillar and channel are made of the same material.

Preferably, the width of the pillar is between 5 μm to 500 μm. In addition, the height of the pillar may be 5 μm to 100 μm.

In an embodiment, there are a plurality of pillars that are equally spaced apart supporting the channel.

Preferably, the substrate is a piezoelectric substrate. The piezoelectric substrate is any piezoelectric material selected from the group comprising: lithium niobate, lithium tantalite, and lanthanum gallium silicate.

Preferably, the acoustic source is an interdigital transducer and the acoustic wave is a single travelling surface acoustic wave or a combination of multiple travelling surface acoustic waves.

The channel may be made from any suitable material. Preferably, the channel is a microchannel having a cross-sectional diameter of less than 1 mm.

Preferably, the surface acoustic wave has an average frequency of between 1 MHz and 1000 MHz.

Preferably, the channel has at least one inlet for receiving the fluid suspension and at least one outlet for discharging the fluid suspension.

Preferably, the particle is less than 50 μm in size.

Preferably, the particles comprises any particles selected from the group: organic particles, inorganic particles, biological cells, and microorganisms.

The key advantage/improvement over existing state-of-the-art methods is that the channel of the present invention device is made of cheap polymer material for sample loading can be effortlessly detached from the SAW transducer after completing the particle manipulation. As such, the processed samples are physically separated from the SAW transducer to avoid cross-contamination or cumbersome washing procedure. The use of micro-pillars for the introduction of SAWs into the channel devices can also minimize the acoustic attenuation before reaching the fluids for particle manipulation.

In order that the present invention may be fully understood and readily put into practical effect, there shall now be described by way of non-limitative examples only preferred embodiments of the present invention, the description being with reference to the accompanying illustrative figures.

In the Figures:

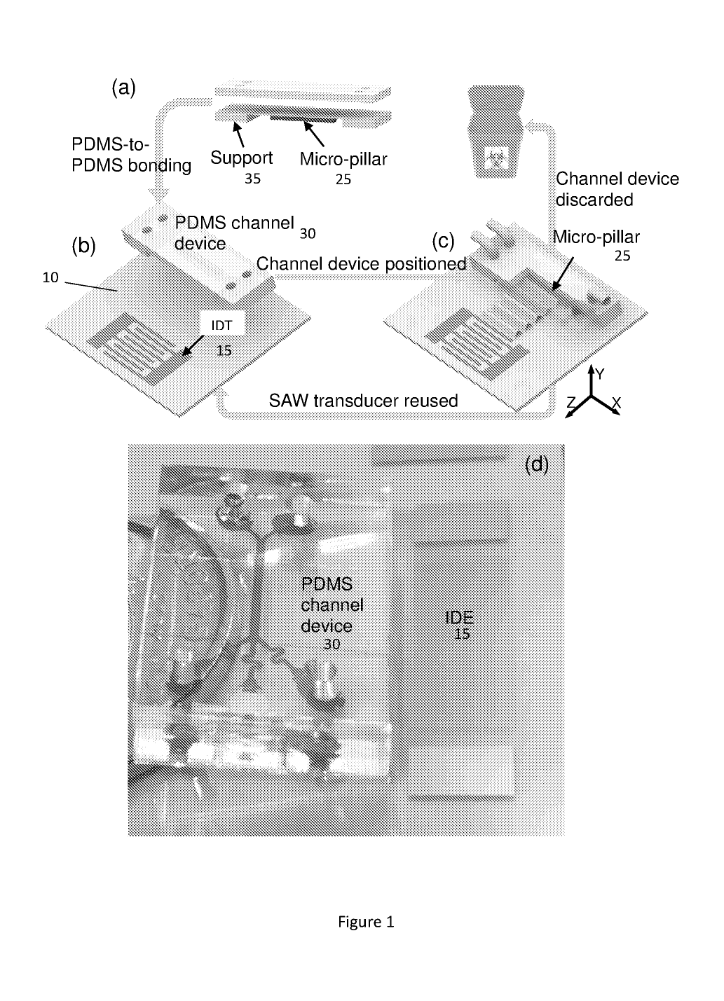

FIG. 1: Operating principle and design of the detachable acoustofluidic system. (a) A PDMS channel and a thin PDMS layer with a micro-pillar and supports are separately fabricated using a standard soft-lithography method. (b) The PDMS channel and micro-pillar layer are bonded after plasma treatment to form the disposable PDMS channel device. (c) The disposable channel device is placed on the SAW transducer, which is a piezoelectric substrate patterned with interdigital electrodes (IDE or IDT). After usage, the channel device can be effortlessly detached and discarded; while the SAW transducer can be reused. (d) Photograph of the detachable acoustofluidic system. A coin is placed between the disposable channel device and the reusable SAW transducer.

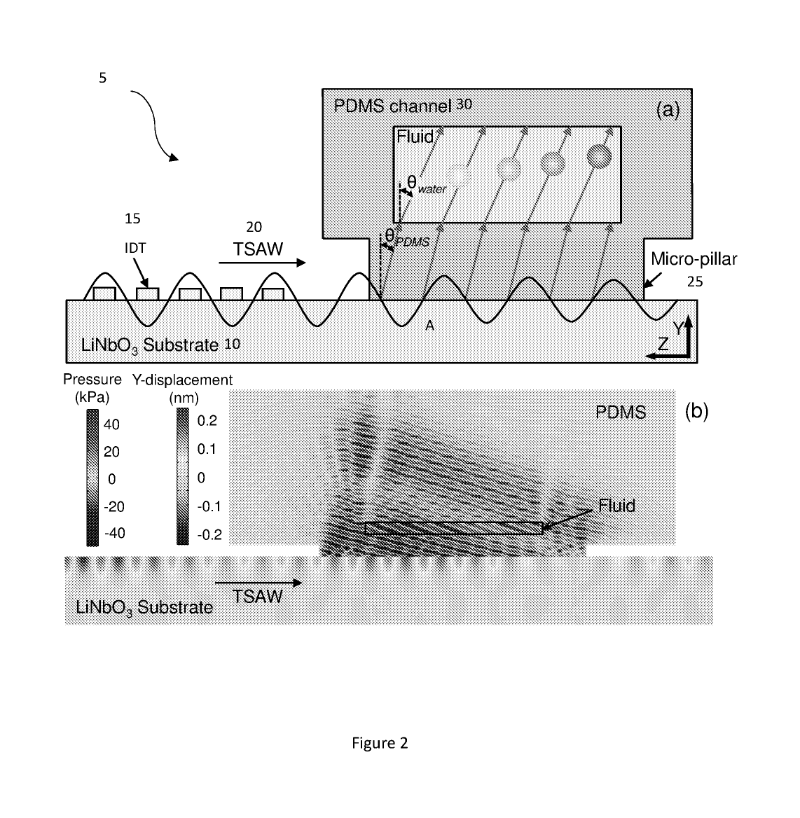

FIG. 2: (a) Schematic illustration of the wave propagation from the SAW transducer to the fluid channel. TSAW is stimulated when applying an AC signal on the IDT deposited on the LiNbO₃ (LN) substrate. The micro-pillar beneath the channel directs the TSAW through the fluid channel for particle manipulation, which can minimize the attenuation along the LN/PDMS interface. (b) Numerical simulation of the wave propagation on the cross-section of the detachable acoustofluidic system.

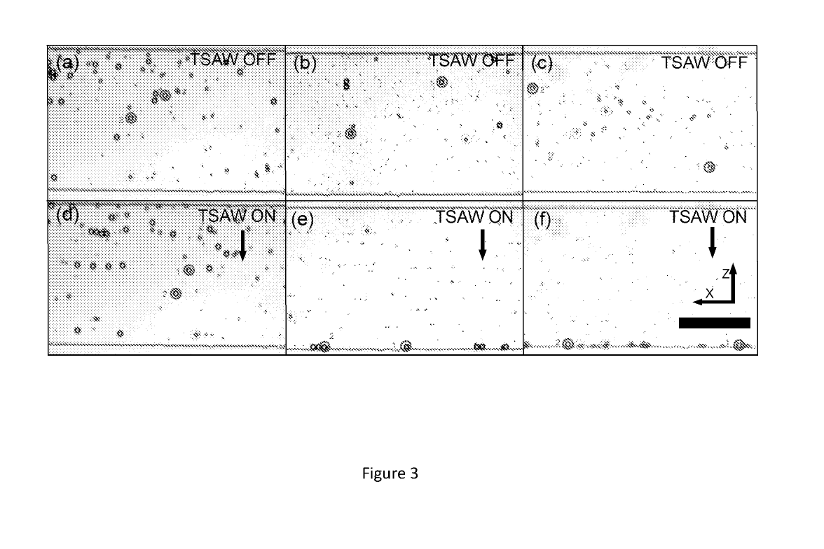

FIG. 3: Responses of differently sized particles in the disposable channel device exposed to TSAW fields with different frequencies. Suspension containing 15 μm, 10 μm, 7 μm and 5 μm particles is introduced to the disposable channel and placed on the SAW transduces with resonant frequency of 24.7 MHz (a, d), 49.5 MHz (b, e) and 99.0 MHz (c, f). (d-f) show the final particle positions after turning on the TSAW for 13 seconds. All the four kinds of particles show no obvious deflection in the 24.75 MHz TSAW field (d), the 15 μm particles are noticeably deflected in 49.5 MHz field (e), while both the 10 μm particles and 15 μm particles are deflected in the 99.0 MHz field (f). To better visualize the different responses in each frequency mode, two of the 15 μm particles (yellow circled) and the 10 μm particles (red circled) are labeled the position before (a-c) and after (d-f) turning on the TSAW. The AC signal applied on the IDT is 10.2 Vpp, generating the TSAW along the z-axis downward. The scale bar is 200 μm.

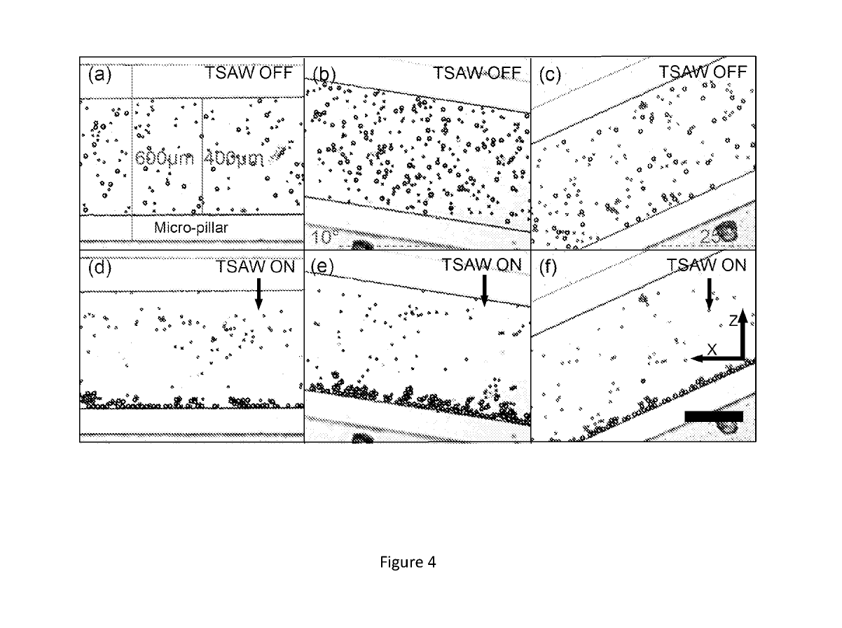

FIG. 4: Deflection of 10 μm and 15 μm particles in the disposable channel at varying orientations with respect to the IDT (a and d: 0°; b and e: 10°; c and f: 25°). The 400 μm wide channel is on the top of the 600 μm wide micro-pillar. In all the three orientations, the 10 μm particles are unresponsive while the 15 μm particles are deflected to the channel wall within a similar time duration by the 49.5 MHz TSAW at 5.0 Vpp. (d-f) show the final particle positions after turning on the TSAW for 12 seconds. This uncompromised particle deflection indicates a high tolerance in the alignment of the channel device with respect to the SAW transducer. The scale bar is 200 μm.

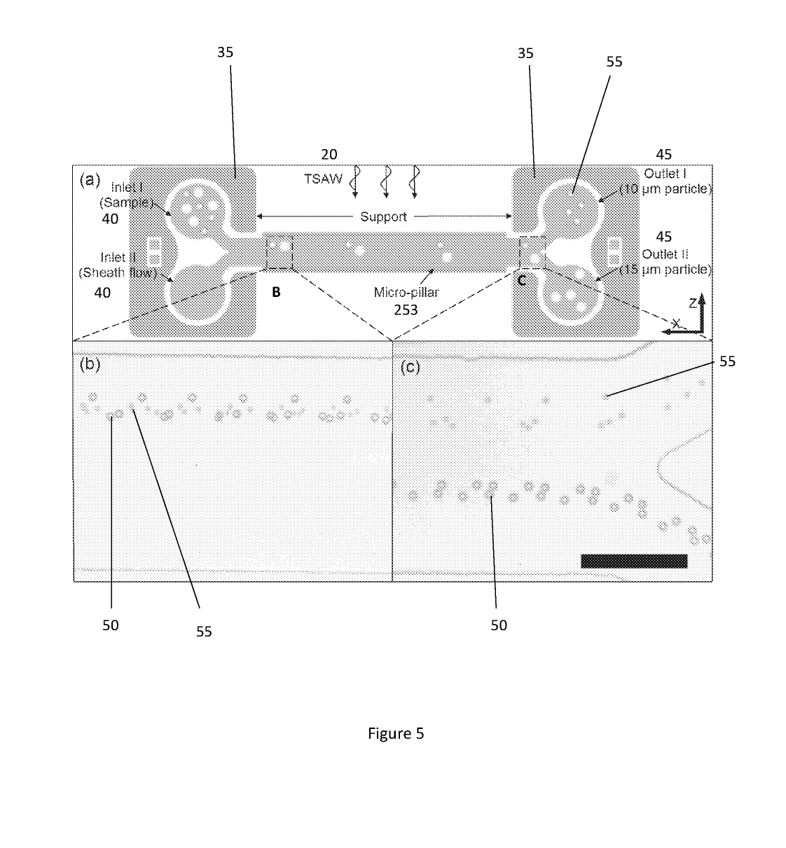

FIG. 5: Size-based separation of 10 μm and 15 μm particles using the detachable acoustofluidic system. (a) Schematic of the experimental setup. The mixed sample suspension and the buffer sheath flow are injected into the inlet I at a flow rate of 5 μl/min and the inlet II at a flow rate of 8 μl/min, respectively. The AC signal applied on the IDT is 22.0 Vpp, generating the 49.5 MHz TSAW along the z-axis downward. (b and c) are time-lapsed images showing the trajectories of the two particles. (b) The 10 μm and 15 μm particles at the inlet junction are hydrodynamically confined near one of the channel walls by the faster sheath flow. (c) After flowing through the 49.5 MHz TSAW field, the 15 μm particles are deflected to the outlet II and the 10 μm particles exit from the outlet I. The scale bar is 200 μm.

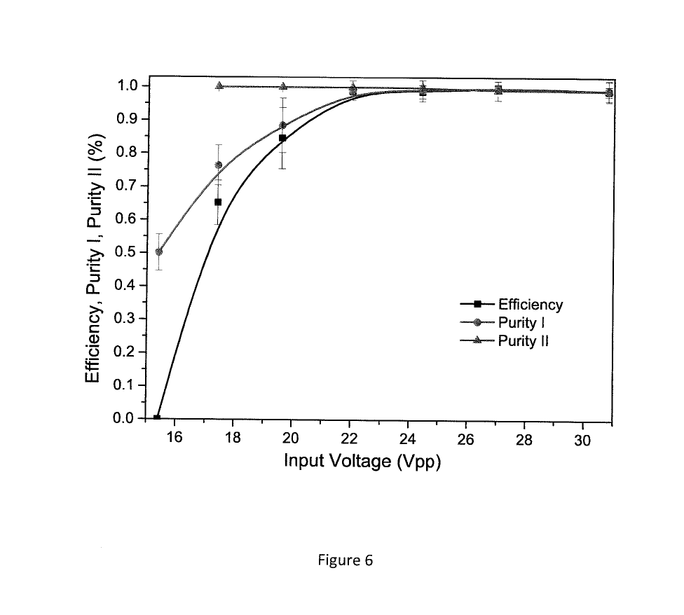

FIG. 6: Correlation between the input voltage applied on the IDT and the separation performance: the percentage of 15 μm particles deflected to the outlet II upon the total 15 μm particles through the channel (separation efficiency), the percentage of 10 μm particles upon the total number of particles collected in the outlet I (purity I) and the percentage of 15 μm particles upon the total number of particles collected in the outlet II (purity II).

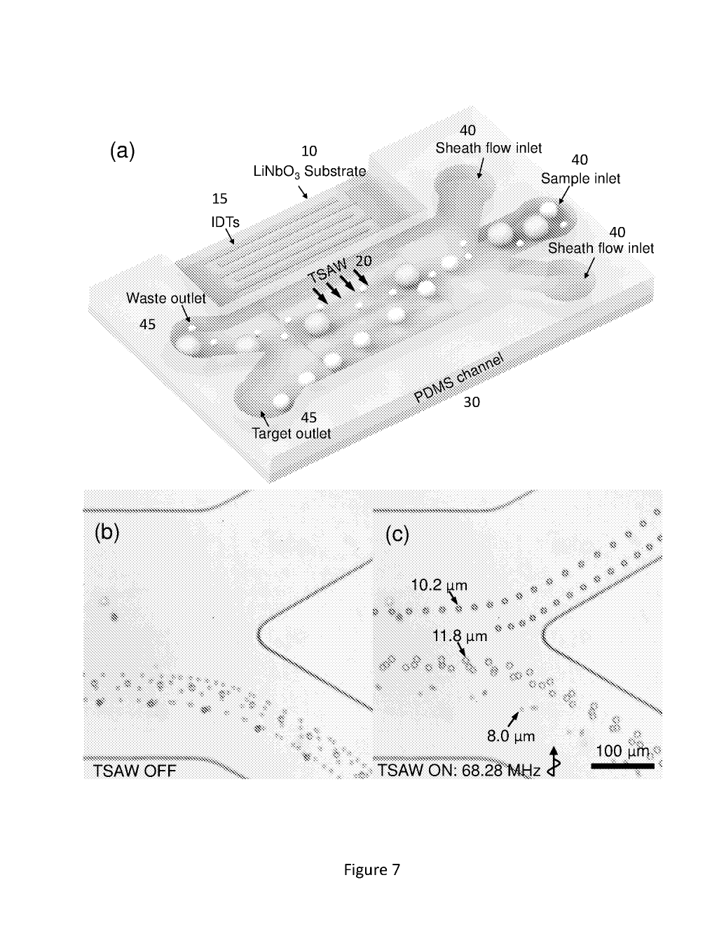

FIG. 7: Size-based bandpass filtration of micron-sized particles in a detachable acoustofluidic system. (a) Schematic layout of the bandpass filter with a localized SAW field in the channel device. An example of bandpass filtration is shown in (b) and (c). All the three particle dimensions (8, 10.2 and 11.8 μm) flow into the waste outlet in the absence of the SAW field (b). When a 68.28 MHz SAW field is introduced into the fluids through a micro-pillar, only the 10.2 μm is transferred laterally into the target outlet and the smaller/larger particles still flow into the waste outlet (c).

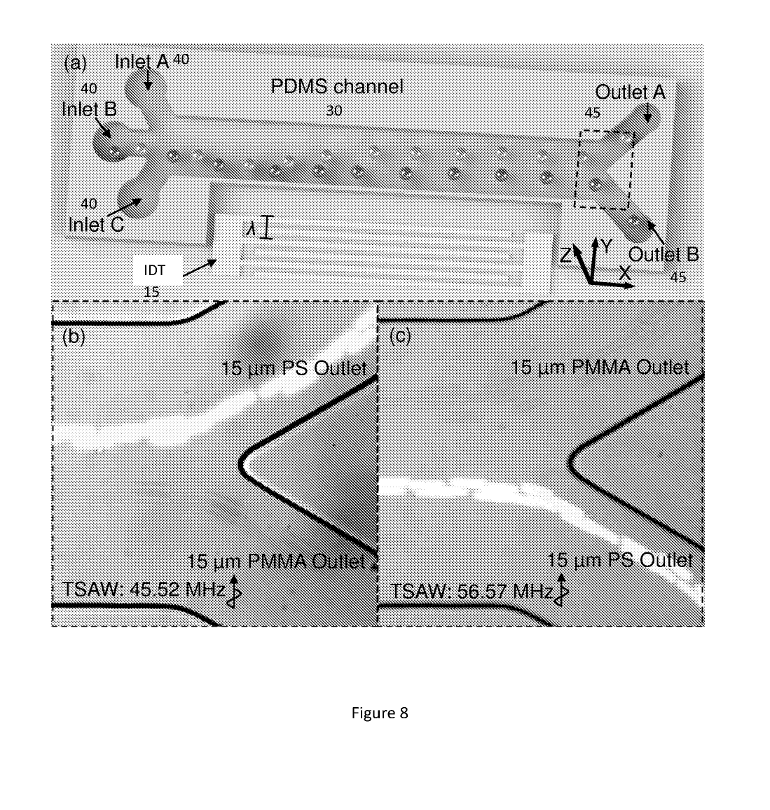

FIG. 8: Acoustic properties based particles separation in a detachable acoustofluidic system. (a) Schematic of the acoustophoretic microfluidic system for particle separation. (b) In the 45.52 MHz TSAW field, the 15 μm PS particles are translated into the upper outlet while the 15 μm PMMA particles keep flowing into the lower outlet. (c) In contrast to the condition in (b), in the 56.57 MHz TSAW field the 15 μm PMMA particles are translated to the upper outlet.

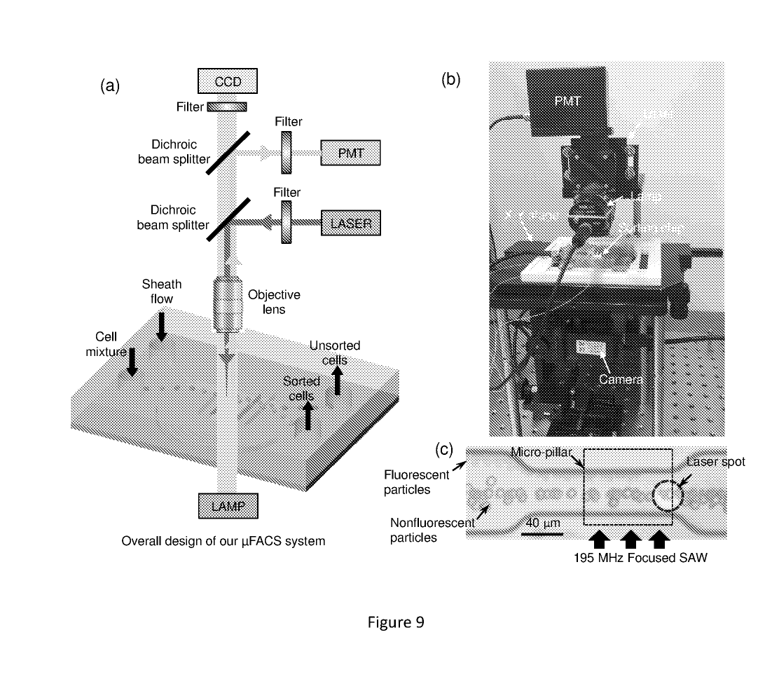

FIG. 9: Acoustic-based microfluidic fluorescence-activated cell sorter (μFACS). (a) Schematic representation and working principle of the proposed μFACS system. (b) Photograph of the μFACS prototype system. (c) Demonstration of the FACS-based sorting of fluorescent and nonfluorescent microbeads. The micro-pillar enables the localization of acoustic field for high-accurate single particle sorting. This image is obtained by superposing sequential images of the FACS process.

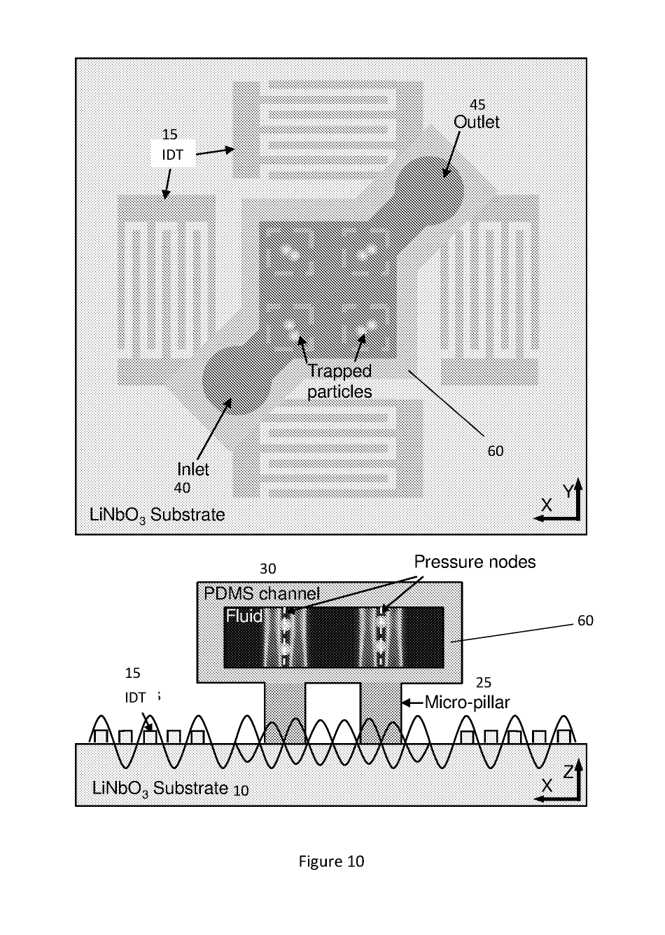

FIG. 10: A schematic diagram illustrating particle trapping in a localized standing acoustic waves via micro-pillar array.

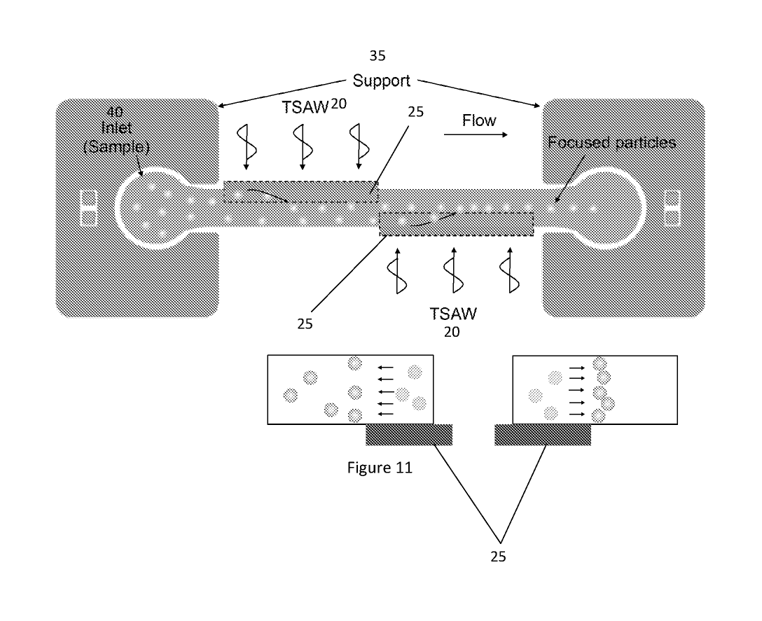

FIG. 11: A schematic diagram illustrating sheathless particle focusing using two oppositely placed micro-pillars.

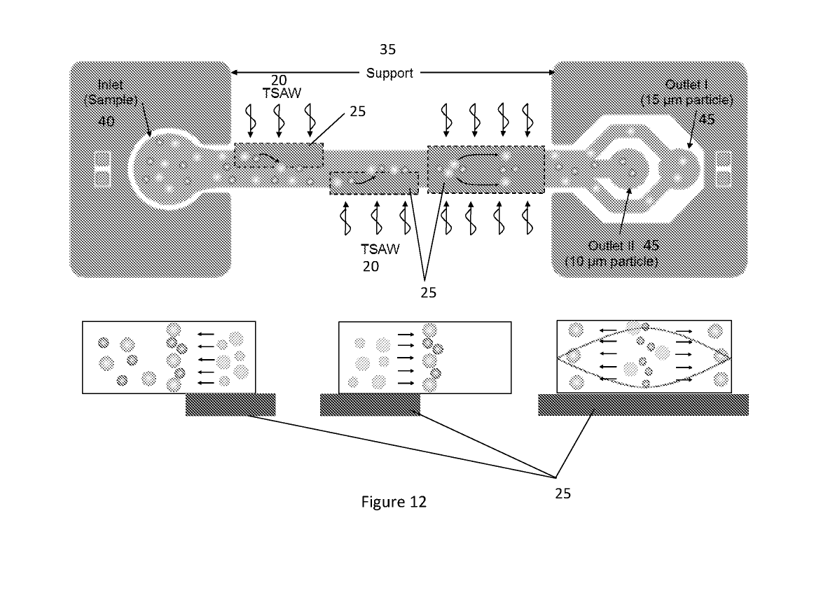

FIG. 12: A schematic diagram illustrating sheathless particle sorting using three-pillar arrangement.

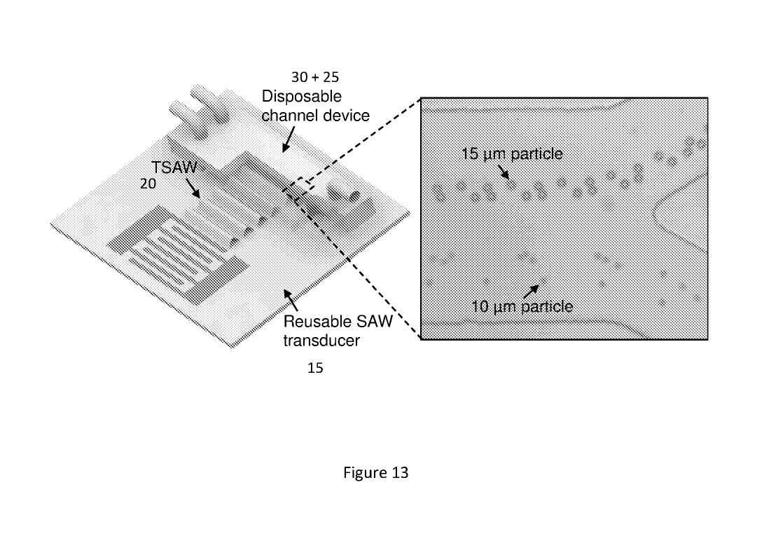

FIG. 13: A schematic diagram showing the device of the present invention in operation.

We present a detachable acoustofluidic system for size-based, acoustic properties based and fluorescence activated continuous particle separation using high frequency TSAW fields. Instead of concentrating particles in periodic pressure nodal positions in a standing field, particles exposed to the travelling field could be constantly displaced in the direction of wave propagation without any inherent limit. Additionally, a micro-structured pillar slightly wider than the microfluidic channel for sample loading is introduced beneath the channel device. The use of this micro-structured pillar ensures a full coverage of the travelling field in the channel region while minimizing the contact area between the channel device and the SAW transducer to reduce wave attenuation. To operate the particle manipulation and separation using the developed detachable acoustofluidic system, a channel device made of polydimethylsiloxane (PDMS) is directly placed onto the SAW transducer with a high tolerance in alignment and orientation. Our system can be easily assembled using naked eyes without the aid of any special tools. After the completion of the particle manipulation, the PDMS channel device can be easily peeled off and discarded because of its relatively low cost; while the SAW transducer can be recycled for future use. We investigate the displacement of particles with varying sizes and acoustic properties (sound speed and density) exposed to TSAWs at different frequencies, aiming to correlate the acoustic frequency with the size of particles that could be effectively manipulated in a TSAW field and to determine the distinct responses of particles made of different materials in the same traveling acoustic field. We also demonstrate the functionality of the developed detachable acoustofluidic system by separating differently sized polystyrene particles using TSAWs with a high separation efficiency of 98%. We also demonstrate the separation of particles with different acoustic properties and fluorescence activated particle sorting. This detachable acoustofluidic system provides a simple and cost effective solution for particle and cell separation in practical biomedical applications.

An embodiment of the detachable acoustofluidic system of the present invention is depicted in FIG. 1. The system consists of a disposable PDMS channel device 30 and a reusable SAW transducer 15. The PDMS channel device 30 is fabricated by bonding the two parts together (FIG. 1a): a top part with cavities to define the channel features and a bottom layer with micron-sized structures to transmit the acoustic field and support the device. The reusable SAW transducer 15 is fabricated by depositing IDT on a lithium niobate (LiNbO₃, LN) piezoelectric substrate 10 (FIG. 1b). The PDMS channel 30 is plugged with inlet and outlet tubes, and then placed on the SAW transducer 15 without any equipment-assisted alignment. Acoustic wave generated by the SAW transducer transmits through the micro-pillar 25 into the channel 30 and thus manipulates particles exposed to the acoustic field. After the completion of the manipulation process, the channel device 30 can be easily peeled off and discarded to prevent cross-contamination, while the SAW transducer 15 left for reuse (FIG. 1c). FIG. 1d shows the fabricated PDMS channel device and SAW transducer to form the detachable acoustofluidic system. FIG. 2a shows a cross-section of the device having the substrate, micro-pillar attached to the substrate, and a channel attached to the channel.

In particular, FIG. 2a shows a device 5 that is suitable for manipulating a particle in a fluid suspension. Such particles may be any particle that is small, or nano in size. Examples include organic particles, inorganic particles, biological cells, microorganisms and the like. Such particles may be less than 50 μm in size.

The device 5 comprises or includes a substrate 10 having a surface. In various embodiments, the material of the substrate 10 may be LiNbO₃. As shown in the figure, the substrate may take any form but typically a flat structure having surfaces on which to support the various other components of the device 5. In various embodiments, the device 5 comprises an acoustic source 15 that is configured to generate and deliver an acoustic wave 20 within a region A of the substrate surface. Said region A may span across the surface of the substrate 10. In various embodiments, the acoustic source 15 may be an interdigital transducer and the acoustic wave 20 is a single travelling surface acoustic wave (SAW) or a combination of multiple travelling surface acoustic waves. In various embodiments, the surface acoustic wave has an average frequency of between 1 MHz and 1000 MHz. On the surface of the substrate 10, there is placed a pillar 25 that is configured to receive or support a channel 30. It is the channel 30 that receives the fluid suspension or has the fluid suspension slowing in it, said fluid suspension contains the particles that are to be manipulated. The acoustic wave 20 that is delivered or that is travelled through or within the region A of the surface of the substrate 10 is then delivered or travels to the fluid suspension in the channel 30 through the pillar 5. The arrows in FIG. 2a show the path taken by the acoustic wave 20.

In the description here, the channel 30 may also be described as an “upper fluid channel”, and it may be part of a larger network of channels that receives or transports the fluid suspension. The particles contained in the fluid suspension are manipulated. The channel 30 is a microchannel having a cross-sectional diameter of less than 1 mm. The channel 30 may be in fluid communication or connected to at least one inlet for receiving the fluid suspension and at least one outlet for discharging the fluid suspension. There may be more than one outlet for transporting the sorted particles.

By “manipulated” or “manipulation”, it is meant to refer to any type of guide, influence or control to the particles by the action of the acoustic wave 20. An example of such an application may be in cell sorting.

Returning to the device 5, the pillar 25 (also described as a “micro-pillar” here) may be configured to be detachably attached to the surface of the substrate 10. Advantageously, the substrate 10 containing the acoustic source 15 may be reused by removing the pillar 25 and channel 30 after each use of the device. Alternatively, the channel 30 may be removed from the pillar 25 and a new channel 30 may be applied to it after each use.

As can be seen in the figure and described in detail below, the pillar 25 may be integral with the channel 30 such that it may form a wall or part of a wall of the channel 30. Here, the pillar 25 forms the base or bottom floor of the channel 30. Naturally, the pillar 25 is made of a material suitable for conducting the acoustic wave 20. Non-limiting examples include glass, polymethylmethacrylate (PMMA), and polycarbonate (PC). In various embodiments, the pillar 25 and channel 30 are made of the same material. Further, the substrate 10, pillar 25 and channel 30 may be made of the same material. Or, they could be made out of different materials. The channel 30 may be made of PDMS and, as described here, may also be known at the PDMS channel device 30.

In various embodiments, the substrate 10 may be made from any piezoelectric material. Non-limiting examples include lithium niobate, lithium tantalite, and lanthanum gallium silicate.

As shown in the figure, the width of the channel 30 is wider than the pillar 25 such that portions of the channel 30 overhang the pillar 25. The pillar 25 may take the form of any shape, e.g. any suitable block. In various embodiments, a length of or the width of the pillar may be between 5 μm to 500 μm. As such, a length of or the width of the channel 30 which is sitting on the pillar 25 is wider than that of the pillar 25.

In other embodiments, there may be more than one pillar 25. There could a plurality of pillars 25 placed under or supporting a channel 30 within the width of the channel 30 where these pillars 25 are equally spaced apart.

FIG. 2a illustrates the process that the wave generated by the SAW transducer transmits into the upper fluid channel. When the IDT is excited by an AC signal at its resonant frequency, the piezoelectric effect can convert the applied AC electric field to propagating mechanical vibration, which is the generation process of a single TSAW. When the TSAW comes into contact with the PDMS micro-pillar on the top of the SAW transducer, it partially radiates into the PDMS at a Rayleigh angle, θ_{PDMS}=arcsin (c_{PDMS}/c_{LN}), where c_{PDMS} and c_{LN} are respectively, the speed of sound in the PDMS and LN. In the system described here, with c_{LN}=3978 m/s and c_{PDMS}=1019 m/s, θ_{PDMS}≈14.8°. The acoustic wave further travels toward the interface between the PDMS and fluid confined in the microfluidic channel, and refracts into the fluid at an angle, θ_{water}=arcsin (sin θ_{PDMS}·c_{water}/c_{PDMS})=arcsin(c_{water}/c_{LN}). With c_{LN}=3978 m/s and c_{water}=1495 m/s, θ_{water}≈22.1°. A particle suspended in the fluid is subjected to an acoustic radiation force when exposed to the TSAW field.¹¹ This radiation force is along the direction of wave propagation, and thus has both horizontal and vertical components. The horizontal component deflects the particle laterally across the channel. Based on the difference in the degree of lateral deflection of particles with varying properties, the TSAW has been used to separate particles of different sizes,¹⁹ and demonstrated for a submicron resolution.²⁰ The vertical component tends to levitate the particle toward the roof of the channel with a slower fluid velocity, which allows the particle to be exposed to the TSAW field for a longer period of time.

A finite element method (FEM) based numerical simulation was conducted via COMSOL Multiphysics 4.3 (www.comsol.com) to study the propagation of TSAW into the disposable PDMS channel. Since both of the IDT aperture and the channel length are large enough to ensure a uniform TSAW field along the longitude direction, a two-dimensional (2D) modeling of the device cross-section can represent the generation and propagation process of the TSAW field. The wave propagation in the piezoelectric substrate is governed by the Maxwell's equations for electric field and the stress-strain equations for mechanical motion;^{28, 29} while the acoustic field in the fluid and PDMS domain is governed by the Helmholtz wave equation.³⁰ FIG. 2b shows the numerical simulation of the TSAW propagation along the LN surface and partial transmission through the micro-pillar into the fluid with a 5.0 Vpp AC signal applied on the IDT. The Rayleigh angles at the LN/PDMS and PDMS/fluid interfaces calculated in the simulation are, respectively, θ_{water}=18°˜22° and θ_{PDMS}=15°˜16°, which are in considerable agreement with the theoretical values.

In addition to the above, FIG. 13 shows a perspective view of the device comprising the reusable substrate (i.e. the substrate comprising the pillar and the acoustic source in the form of a SAW transducer), and the disposable channel which the pillar is configured to receive. As such, as shown in this figure, the channel may be adhered to the pillar by any means such as the channel is easily removable and may be disposed after each use. A fresh or new channel device may then be used for the next particle manipulation/sorting exercise by adhering the new channel to the pillar associated with the substrate and the SAW transducer.

### EXAMPLE

Materials and Methods

1. Fabrication of Disposable PDMS Channel Device

The disposable channel device consists of two parts: a top layer with channel-feature cavities and a bottom layer with a micro-pillar and supporting structures. The two parts were produced using a standard soft lithography technique based on a 25 μm thick layer of SU-8 photoresist (SU-8 25, MicroChem Corp., Newton, USA) micro-structures on silicon wafers. To fabricate the top layer, a degassed mixture of PDMS pre-polymer and curing agent (Sylgard184 Silicone Elastomer Kit, Dow Corning Corp., Freeland, USA) with a weight ratio of 10:1 was poured on the mold and cured at 75° C. for 2 hours. The channel is 7 mm long and 400 μm wide. To obtain the bottom layer, the same PDMS mixture was spin-coated on another pre-fabricated SU-8 mold to form a 50 μm layer with 25 μm thick micro-pillar and supporting structures at the bottom. The micro-pillar for guiding the wave transmission into the fluid is 6.3 mm long and 600 μm wide. The PDMS was cured at 75° C. for 2 hours. Then the top part with channel patterns was demolded and punched holes for inlets and outlets. After an air plasma treatment for 150 seconds at 18 W, the top layer was brought into firm contact with the bottom layer which had not been demolded and then heated at 95° C. for 15 minutes. Prior to the permanent bonding, the top layer was aligned with the bottom layer using a 6 DOF micro-positioning system under a high magnification camera (AM4115TL, AnMo Electronics Corporation, Taiwan), which ensured that the 400 μm wide channel was right on the top of the 600 μm wide micro-pillar. After cooling down, the bonded PDMS channel was peeled off from the micro-pillar mold and ready for use.

2. Fabrication of Reusable SAW Transducer

The reusable SAW transducer was fabricated by depositing IDT on a LN piezoelectric substrate with a lift-off technique. Briefly, a layer of Cr (5 nm) and a layer of Pt (80 nm) were sequently deposited on a 500 μm thick 128° rotated Y-cut X-propagating LN substrate with a 1.4 μm thick pre-patterned photoresist layer (AZ 5214, MicroChemicals, Germany) using an electron beam evaporator. Then the substrate was sonicated in acetone to wash away the undesired metallic region. The IDT has 20 electrode finger pairs with 160/87/80/70/40 μm finger pitch to stimulate equivalent wavelength TSAW. AC sinusoidal signals at corresponding resonance frequencies about 24.7/45.5/49.5/56.6/99.0 MHz were applied on the IDT to generate TSAW fields during the experiments.

3. Setup of Fluidic System

In the study of particle deflections in TSAW fields at different frequencies, as well as the study of the alignment tolerance, the suspensions containing differently sized polystyrene particles were slowly injected into the disposable channels with syringe. Then the inlet and outlet tubes were blocked to minimize the fluid flow in the channels. In the size based particle separation experiments, the flow rates of the sample flow and the sheath flow were, respectively, 5 μl/min and 8 μl/min, driven by two separate syringe pumps (KD Scientific, USA). In the single IDT actuated bandpass filtration experiment, the flow rates of the sample flow and the upper and the lower sheath flows were, respectively, 2 μl/min, 4 μl/min and 1.5 μl/min. In the acoustic properties based particle separation experiments, the flow rates of the sample flow and the upper and the lower sheath flows were, respectively, 1 μl/min, 4 μl/min and 1.5 μl/min. In the fluorescence activated particles sorting experiment, the flow rates of the sample flow, the upper and the lower sheath flows were, respectively, 0.2 μl/min, 0.5 μl/min and 0.1 μl/min.

4. Evaluation of Particle Separation

During the separation experiments, the bifurcation area of the outlets was monitored under a high-speed camera (Photron Inc., USA) at a frame rate of 4000 fps. The particle separation process was captured for 1 second randomly during the separation experiments, generating 4000 consecutive images in each video with about 20-30 particles flowing through the channel. The numbers of differently sized particles into different outlets were counted in multiple videos to calculate the separation efficiency and the purity of separated samples.

Results and Discussion

1. Particle Deflection in TSAW Fields

Deflection experiments were conducted under a series of different frequencies to find an appropriate frequency for separating several certain differently sized particles. The aqueous suspension containing particles with diameters of 5 μm, 7 μm, 10 μm and 15 μm was injected and kept in a minimized fluid flow in the disposable channel device placed on the SAW transducers with resonance frequencies at 24.7 MHz, 49.5 MHz and 99.0 MHz (FIGS. 3a-3c). The sinusoidal signal at respective resonance frequency was turned on for 13 seconds and the final positions of the tracked particles are shown in FIGS. 3d-3f. For a low frequency at 24.7 MHz (FIGS. 3a and 3d), none of the four kinds of particles was deflected to the channel wall on the opposite side of the TSAW source, which implies that the radiation force at 24.7 MHz was not strong enough to manipulate particles exposed to the TSAW field. For a higher frequency at 49.5 MHz (FIGS. 3b and 3e), only 15 μm particles were effectively deflected to the channel wall. The 10 μm particles were very slightly displaced, however could not reach the channel wall. The 5 μm and 7 μm particles were not deflected at all. For an even higher frequency at 99.0 MHz, both the 15 μm and 10 μm particles were rapidly deflected to the channel wall. The 7 μm particles were deflected slightly and could not reach the channel wall, similar to the 10 μm particles in the 49.5 MHz TSAW field. The 5 μm particles showed no deflection. We found that nontrivial particle deflection only occurs for particles above a cutoff size at a given TSAW frequency. This cutoff particle size could be determined by a dimensionless factor, κ=k·r, where r is the radius of the particle, k=2πf/c_{f} such that f is the wave frequency and c_{f} is the speed of sound in the fluid. Table 1 summarizes the κ factor values for the four particles at the three different TSAW frequencies in our experiments.

TABLE 1
κ factor values against frequency f and particle diameter d

Particle size d = 2r (μm)

| Frequency f (MHz) | 15 | 10 | 7 | 5 |
|---|---|---|---|---|
| 24.7 | 0.78 | 0.52 | 0.36 | 0.26 |
| 49.5 | 1.56 | 1.04 | 0.73 | 0.52 |
| 99.0 | 3.12 | 2.08 | 1.46 | 1.04 |

The experimental observation reveals that the threshold value of the κ factor is between 1.46 and 1.56. This critical value is attributed to the fact that anisotropic acoustic scattering dramatically increases when the κ factor is beyond a certain value so that a nontrivial net force is exerted on the particle in the direction of wave propagation. This cutoff particle size for effective deflection is useful to remarkably improve the resolution of size-based particle separation. For example, by choosing the cutoff size between the diameters of two particles, it has been demonstrated to separate 3.2 μm particles from 3.0 μm particles, yielding a separation resolution as low as 0.2 μm.²⁰ Since the cutoff particle size in the 49.5 MHz TSAW is between 10 m and 15 μm, we decided to separate the 10 μm and 15 μm particles in the 49.5 MHz TSAW.

2. Alignment Tolerance in System Assembly

The major merit of the detachable acoustofluidic system is that the channel device for sample loading can be physically separated from the sample manipulation device to avoid cross-contamination. Ideally, the TSAW should be perpendicular to the flow direction to minimize the particle deflection required for efficient particle separation. But precise alignment is not a critical step in the assembly process of our system. Therefore, another merit for users to operate this system is that the disposable channel device can be easily placed on the SAW transducer with naked-eye precision in the absence of any equipment assistance.

To demonstrate the high tolerance in alignment and orientation of the channel placement, the disposable channel containing 10 μm and 15 μm particle suspension in a minimized flow condition was differently placed on the 49.5 MHz SAW transducer. We applied a low input signal voltage at 5.0 Vpp to make the deflection process to be observable. FIGS. 4a and 4d show the ideal placement of the channel device on the SAW transducer in which the TSAW is perpendicular to the flow direction. As discussed previously, only the 15 μm particles were selectively deflected to the opposite channel wall within 12 seconds in the 49.5 MHz TSAW. The channel device was then rotated 10° in the clockwise direction (FIGS. 4b and 4e), all the 15 μm particles were also deflected to the opposite wall within 12 seconds. When the channel was placed at an angle of 25° with respect to the SAW transducer (FIGS. 4c and 4f), a complete deflection of the 15 μm particles to the opposite wall within 12 seconds was consistently observed. This high tolerance in alignment can be understood by the fact that the TSAW is unidirectionally moving particles in the wave propagation rather than moving particles to periodic pressure nodal or anti-nodal positions in which the channel alignment is critical.

3. Size-Based Particle Separation in the Detachable Acoustofluidic System

We further demonstrated the separation of 10 μm and 15 μm polystyrene particles in a 49.5 MHz TSAW, as illustrated in FIG. 5a. FIG. 5a shows a top view of the device 5. Here, it can be seen that the device 5 comprises the substrate 10. The acoustic source 15 generates and deliver the acoustic wave (TSAW) across the surface of the substrate 10. The channel 30 sits on the pillar 25. The acoustic wave 20 (shown in arrows) is delivered through or within the surface of the substrate 10 is then delivered or travels to the fluid suspension in the channel 30 through the pillar 25. Here, there are additional supports 35 for supporting the inlets 40 and outlets 45 that are connected or in fluid communication with the channel 30. Here, there are 2 inlets 40 and 2 outlets 45. The portion B is expanded in FIG. 5b, while the portion C is expanded in FIG. 5c. It can be seen how the particles suspended in the fluid that is travelling from B to C in the channel 30 are being manipulated. The larger sized particles 50 are being directed or pushed to a side of the channel 30 and they exit in the lower outlet 45 rather than the upper one exited by the smaller sized particles 55. The particles in the fluid suspension travelling along the channel 30 exposed to the acoustic wave are being manipulated through the substrate 10 and pillar 25.

The mixed particle sample was introduced to a disposable channel device via inlet I at a flow rate of 5 μl/min. Inlet II receives a sheath flow. In other embodiments, there may be 2 inlets for fluid suspension while a third inlet receives a sheath flow. The two types of particles were confined in the region near the channel wall closer to the TSAW source by a sheath flow at a rate of 8 μl/min as shown in FIG. 5b. The confined particles flowed through a 6.3 mm long TSAW field transmitted via the micro-pillar beneath the channel. As observed in FIG. 3, the cutoff particle size in the 49.5 MHz TSAW is between 10 μm and 15 μm, therefore the 15 μm particles were effectively deflected to the opposite channel wall and flowed into outlet II; while the 10 μm particles followed the fluid streamline and flowed into outlet I as shown in FIG. 5c.

Separation experiments with the same flow condition at varying input voltages were conducted to evaluate the correlation between the separation performance and the strength of the TSAW field, as shown in FIG. 6. The trajectories of all the particles at the outlet junction were tracked using a high-speed camera. Separation efficiency is defined as the percentage of 15 μm particles deflected to the outlet II upon the total 15 μm particles flowing through the channel. When the input voltage was lower than 15.4 Vpp, no 15 μm particles could be effectively deflected and all of them flowed into the outlet I following the streamline. As the input voltage further increases, the separation efficiency noticeably increases. When the input voltage was above 22.0 Vpp, a high efficiency above 98% could be achieved. Purity I and II are defined as the percentage of 10 μm and 15 μm particles upon the total number of particles collected in the outlet I and II, respectively. Once the input voltage was above 15.4 Vpp, the 15 μm particles were gradually depleted from the original mixed particle sample. Thus, Purity I also increases with the input voltage and reaches 99% above 22.0 Vpp. Purity II always stays at a high value above 99% once the input voltage was above 15.4 Vpp. But the 15 μm particles collected in the outlet II were only above 98% recovered from the original mixture at an applied voltage above 22.0 Vpp, as indicated by the separation efficiency.

4. Single Actuator Bandpass Microparticle Filtration in the Detachable Acoustofluidic System

Using the localized acoustic field in microchannels introduced by micro-pillars beneath the channel, we have realized a single SAW actuated bandpass filter that can selectively sort out particles with dimensions between smaller and larger diameter populations (FIG. 7a). The device 5 shown in FIG. 7a is similar to the device 5 shown in FIG. 5 and described earlier. Here, there are 3 inlets with one target outlet for guiding the manipulated particles of interest (target) and one waste outlet to discard the unwanted fluid and/or particles. This bandpass filter takes advantage of the sharply nonlinear force scaling in the regime where the particle diameter is on the order of the wavelength or larger. We have demonstrated the bandpass filtration using different sets of mixed particle populations. For example, this bandpass filter can efficiently separate 10.2 μm particles out of 8.0 μm and 11.8 μm ones (FIGS. 7b and 7c).

5. Acoustic Properties Based Particle Separation in the Detachable Acoustofluidic System

We further demonstrated acoustic properties based particle separation in the detachable acoustofluidic system. A schematic of the device is shown in the FIG. 8a, the particles with same size (15 μm) but made of different materials (PS and PMMA) in the sample flow are bounded by two sheath flows and are focused into the lower (non-sorted) outlet without the application of TSAW. Once an AC signal is applied to the IDTs, the TSAW generated by the transducer couples into the microchannel via a micro-pillar beneath the channel, which subsequently act to translate the desired particle population into different outlets. In FIG. 8, it can be seen that the acoustic source 15 (IDT) may run a length of the channel 30 with the pillar 25 supporting beneath the channel 30.

To demonstrate the effective separation according to the difference in particle's acoustic properties, we utilize our acoustophoretic microfluidic system to separate 15 μm PS (fluorescent) and 15 μm PMMA (plain) particles in a 45.52 MHz TSAW field, corresponding to K=1.43, at which the ARF imparted on PS particles is maximized relative to that on PMMA ones. With an applied power of 50 mW, the PS particles were selectively translated to outlet A in the direction of wave propagation (farther from the IDTs), while the PMMA particles still exited the sorting region via outlet B, as shown in FIG. 8b. Similarly, the PMMA particles can be selectively translated at K value conditions that maximize the force imparted on them relative to those of PS. Accordingly, we performed the selective PMMA particle separation in a 56.57 MHz TSAW field, corresponding to K=1.78 at an applied power of 48 mW, as shown in FIG. 8c.

6. Fluorescence Activated Cell Sorting in the Detachable Acoustofluidic System

We have also developed a benchtop-scale microfluidic fluorescence-activated cell sorting (μFACS) system consisting of a fluorescence detection system and an acoustic single cell level sorting chip. FIG. 9a shows the schematic representation and working principle of the μFACS system. When a single target cell with fluorescent labels passes through the laser line, the emitted fluorescence light is transmitted back and reflected by a dichroic beam splitter (DBS) to a photomultiplier tube (PMT) via a bandpass optical filter. The signal detected by PMT then activates the acoustic cell-sorting chip to generate a pulse of focused surface acoustic wave (FSAW) beam that can rapidly deflect the detected target cell to the collection outlet. The cell sorting process can be visualized through the CCD camera. FIG. 9b shows the photograph of the developed μFACS prototype system. In the sorting chip, the micro-pillar structure beneath the channel can direct SAWs from the piezoelectric substrate (i.e. acoustic generator) to the microfluidic channel, which enables the localization of acoustic field in a microscale region to implement single particle level sorting. In particular, this working scheme allows a detachable acoustofluidic sorting, in which the microfluidic channel device for sample loading is disposable for single use and the SAW transducers for sample manipulation are reusable. FIG. 9c shows an example of the FACS-based sorting of fluorescent and nonfluorescent microbeads using a detachable acoustofluidic sorting device.

7. Arbitrary Particles Trapping in the Detachable Acoustofluidic System with Micro-Pillar Array or any Arbitrary Patterns

Another embodiment of the present acoustofluidic system is depicted in FIG. 10. Particles suspended in the chamber can be trapped in arbitrary positions (known as “pressure nodes”) where the pre-patterned micro-pillar are located. The chamber 60 may be surrounded by an acoustic source 15 on all sides. The chamber 60 as shown in the figure has 4 sides, hence an acoustic source 15 is position adjacent each side of the chamber 60. The chamber 60 may be in fluid communication with an inlet and an outlet. The two-dimensional standing surface acoustic waves on the substrate surface transmit through the micro-pillars 25 and form localized standing acoustic field in the liquids above the micro-pillar patterns. FIG. 10b shows a side view so that each pillar 25 below the chamber 60 may be shown. The technique of trapping particles or cells in predefined position is of importance for single cell analysis and cell-cell interaction research.

Another embodiment of the present acoustofluidic system is depicted in FIG. 11. Particle focusing into a tightly confined stream is needed in various microfluidic applications for example single cell analysis and cell sorting. It is typically implemented by faster sheath flows to hydrodynamically focus the particle stream, which complicate the fluid control and consume extra buffer solutions. The embodiment in FIG. 11 shows a sheathless particle focusing approach by introduction two micro-pillars disposed between the surface of the substrate and the channel. Each of the two micro-pillars only partially covers the channel width, which localize the travelling SAW within the region where the pillar and the channel overlaps. The localized acoustic field repels flow-through particles toward the edge of the pillar that is away from the SAW source. Therefore, two oppositely placed pillars, each of which covers half of the channel width, can result in a highly confined particle stream along the centerline of the channel, as shown in FIG. 11.

FIG. 12 shows yet another embodiment of the detachable acoustofluidic system of the present invention. As discussed previously, particle focusing is usually a necessary step prior to particle sorting, aiming to produce a confined and deterministic particle flow into the sorting region. The embodiment in FIG. 12 combines the sheathless particle focusing described in FIG. 11 and a standing SAW-based particle sorting unit downstream, which provides a new solution of sheathless particle sorting. The preferred frequency of generating the travelling SAW for sheathless particle focusing should ensure all the flow-through particles to be effectively focused. The standing SAW field is introduced to the fluidic channel via a third micro-pillar that fully covers the channel width. The preferred frequency of generating the standing SAW for particle sorting should cause distinct lateral movements of particles with different properties, which is the key to implement an efficient particle sorting.

### CONCLUSION

We present a detachable acoustofluidic system consisting of a disposable PDMS channel device and a reusable SAW transducer for size-based, acoustic properties based and fluorescence activated continuous particle separation via a TSAW field. The channel device for sample loading can be reversibly attached on the SAW transducer for non-contact particle manipulation. The placement of the channel device on the SAW transducer can be implemented using naked eyes without the aid of any special alignment tools. The high tolerance in alignment has been demonstrated by an uncompromised particle deflection toward one of the channel walls even with an imposed 25° angle between the channel and the SAW transducer. The easy assembly of the system brings a great convenience for users to operate this system. Various deflection experiments under different frequency TSAW fields have found that effective particle manipulation only occurs for particles above a cutoff size, which could be determined by a dimensionless factor, κ=2πfr/c_{f}. We have demonstrated an efficient separation with efficiency above 98% of 10 μm and 15 μm particles in a 49.5 MHz TSAW with a cutoff particle size in-between. Moreover, we have demonstrated acoustic properties based separation of same-sized particles in a continuous flow. By introducing different arrangments of the micro-pillars, it is able to produce various particle manipulations, for example localized particle patterning, sheathless particle focusing, and sheathless particle sorting. The developed detachable acoustofluidic system is greatly useful in practical biomedical applications, where the cheap channel device in direct contact with biological samples can be discarded to avoid cross-contamination while the elaborated SAW transducer can be reused to minimize the cost.

Whilst there has been described in the foregoing description preferred embodiments of the present invention, it will be understood by those skilled in the technology concerned that many variations or modifications in details of design or construction may be made without departing from the present invention.

### REFERENCES

1. K. Schriebl, S. Lim, A. Choo, A. Tscheliessnig and A. Jungbauer, Biotechnology journal, 2010, 5, 50-61.
2. Y. Song, A. Sonnenberg, Y. Heaney and M. J. Heller, Electrophoresis, 2015, 36, 1107-1114.
3. Y. Kang, D. Li, S. A. Kalams and J. E. Eid, Biomedical microdevices, 2008, 10, 243-249.
4. H. W. Hou, M. E. Warkiani, B. L. Khoo, Z. R. Li, R. A. Soo, D. S.-W. Tan, W.-T. Lim, J. Han, A. A. S. Bhagat and C. T. Lim, Scientific reports, 2013, 3, 1259.
5. M. E. Warkiani, G. Guan, K. B. Luan, W. C. Lee, A. A. S. Bhagat, P. K. Chaudhuri, D. S.-W. Tan, W. T. Lim, S. C. Lee and P. C. Chen, Lab on a Chip, 2014, 14, 128-137.
6. K.-H. Han and A. B. Frazier, Journal of Applied Physics, 2004, 96, 5797-5802.
7. J. K. Lim, D. C. J. Chieh, S. A. Jalak, P. Y. Toh, N. H. M. Yasin, B. W. Ng and A. L. Ahmad, Small, 2012, 8, 1683-1692.
8. J. H. Jung, K. H. Lee, K. S. Lee, B. H. Ha, Y. S. Oh and H. J. Sung, Microfluidics and nanofluidics, 2014, 16, 635-644.
9. Y. Li, H. Xin, C. Cheng, Y. Zhang and B. Li, Nanophotonics, 2015, 4, 353-360.
10. P. Li, Z. Mao, Z. Peng, L. Zhou, Y. Chen, P.-H. Huang, C. I. Truica, J. J. Drabick, W. S. El-Deiry and M. Dao, Proceedings of the National Academy of Sciences, 2015, 112, 4970-4975.
11. K. Yosioka and Y. Kawasima, Acta Acustica united with Acustica, 1955, 5, 167-173.
12. M. C. Jo and R. Guldiken, Sensors and Actuators A: Physical, 2012, 187, 22-28.
13. J. Shi, H. Huang, Z. Stratton, Y. Huang and T. J. Huang, Lab on a Chip, 2009, 9, 3354-3359.
14. F. Petersson, A. Nilsson, C. Holm, H. Jonsson and T. Laurell, Lab on a Chip, 2005, 5, 20-22.
15. F. Petersson, L. Aberg, A.-M. Swärd-Nilsson and T. Laurell, Analytical chemistry, 2007, 79, 5117-5123.
16. T. Laurell, F. Petersson and A. Nilsson, Chemical Society Reviews, 2007, 36, 492-506.
17. R. J. Shilton, M. Travagliati, F. Beltram and M. Cecchini, Advanced Materials, 2014, 26, 4941-4946.
18. D. J. Collins, A. Neild and Y. Ai, Lab on a Chip, 2016. 16: p. 471-479.
19. G. Destgeer, K. H. Lee, J. H. Jung, A. Alazzam and H. J. Sung, Lab Chip, 2013, 13, 4210-4216.
20. G. Destgeer, B. H. Ha, J. H. Jung and H. J. Sung, Lab Chip, 2014, 14, 4665-4672.
21. Z. Ma, J. Guo, Y. J. Liu and Y. Ai, Nanoscale, 2015, 7, 14047-14054.
22. D. J. Collins, B. Morahan, J. Garcia-Bustos, C. Doerig, M. Plebanski and A. Neild, Nature communications, 2015, 6, 8686.
23. J. Shi, D. Ahmed, X. Mao, S.-C. S. Lin, A. Lawit and T. J. Huang, Lab on a Chip, 2009, 9, 2890-2895.
24. Y. Chen, S. Li, Y. Gu, P. Li, X. Ding, L. Wang, J. P. McCoy, S. J. Levine and T. J. Huang, Lab on a Chip, 2014, 14, 924-930.
25. G. Destgeer and H. J. Sung, Lab on a Chip, 2015, 15, 2722-2738.
26. Y. Ai, C. K. Sanders and B. L. Marrone, Analytical chemistry, 2013, 85, 9126-9134.
27. X. Ding, Z. Peng, S.-C. S. Lin, M. Geri, S. Li, P. Li, Y. Chen, M. Dao, S. Suresh and T. J. Huang, Proceedings of the National Academy of Sciences, 2014, 111, 12992-12997.
28. M. K. Tan, J. R. Friend, O. K. Matar and L. Y. Yeo, Physics of Fluids, 2010, 22, 112112.
29. Y. Ai and B. L. Marrone, Microfluid. Nanofluid., 2012, 13, 715-722.
30. J. Guo, Y. Kang and Y. Ai, J. Colloid Interface Sci., 2015, 455, 203-211.

1. A device for manipulating a particle in a fluid suspension, the device comprising:
(a) a substrate having a surface;
(b) an acoustic source configured to generate and deliver an acoustic wave within a region of the substrate surface; and
(c) the surface of the substrate is configured to receive a pillar and the pillar is configured to receive a channel, the channel configured to receive the fluid suspension,
wherein the acoustic wave delivered within the region of the substrate surface is delivered to the fluid suspension in the channel through the pillar.

2. The device according to claim 1, wherein the pillar is configured to be detachably attached to the surface of the substrate.

3. The device according to claim 1, wherein the pillar forms a wall or part of a wall of the channel.

4. The device according to claim 1, wherein the pillar is made of a material suitable for conducting an acoustic wave, the material is selected from the group consisting of: glass, polymethylmethacrylate (PMMA), and polycarbonate (PC).

5. (canceled)

6. (canceled)

7. (canceled)

8. The device according to claim 1, further comprising a plurality of pillars that are equally spaced apart.

9. The device according to claim 1, wherein the substrate is a piezoelectric substrate, the piezoelectric substrate is a piezoelectric material selected from the group consisting of: lithium niobate, lithium tantalite, and lanthanum gallium silicate.

10. (canceled)

11. The device according to claim 1, wherein the acoustic source is an interdigital transducer and the acoustic wave is a single travelling surface acoustic wave or a combination of multiple travelling surface acoustic waves.

12. (canceled)

13. The device according to claim 1, wherein the surface acoustic wave has an average frequency of between 1 MHz and 1000 MHz.

14. The device according to claim 1, wherein the channel having at least one inlet for receiving the fluid suspension and at least one outlet for discharging the fluid suspension.

15. The device according to claim 1, wherein the particle is less than 50 μm in size.

16. (canceled)

17. A method for manipulating a particle in a fluid suspension, the method comprising:
(a) providing a substrate having a surface;
(b) providing an acoustic source;
(c) providing a pillar disposed on the surface of the substrate, the pillar configured to receive a channel and the channel configured to receive the fluid suspension; and
(d) manipulating the particle in the channel by using the acoustic source to generate and deliver an acoustic wave to the fluid suspension in the channel through the substrate and pillar.

18. The method according to claim 17, wherein the pillar is configured to be detachably attached to the surface of the substrate.

19. The method according to claim 17, wherein the pillar forms a wall or part of a wall of the channel.

20. The method according to claim 17, wherein the pillar is made of a material suitable for conducting an acoustic wave, the material is selected from the group consisting of: glass polymethylmethacrylate (PMMA), and polycarbonate (PC).

21. (canceled)

22. (canceled)

23. (canceled)

24. The method according to claim 17, further comprising a plurality of pillars that are equally spaced apart.

25. The method according to claim 17, wherein the substrate is a piezoelectric substrate, the piezoelectric substrate is a piezoelectric material selected from the group consisting of: lithium niobate, lithium tantalite, and lanthanum gallium silicate.

26. (canceled)

27. The method according to claim 17, wherein the acoustic source is an interdigital transducer and the acoustic wave is a single travelling surface acoustic wave or a combination of multiple travelling surface acoustic waves.

28. (canceled)

29. The method according to claim 17, wherein the surface acoustic wave has an average frequency of between 1 MHz and 1000 MHz.

30. The method according to claim 17, wherein the channel having at least one inlet for receiving the fluid suspension and at least one outlet for discharging the fluid suspension.

31. (canceled)

32. (canceled)

33. A device for manipulating a particle in a fluid suspension, the device comprising:
(a) a substrate having a surface;
(b) an acoustic source configured to generate and deliver an acoustic wave within a region of the substrate surface;
(c) a channel configured to receive the fluid suspension; and
(d) a pillar disposed between the surface of the substrate and the channel,
wherein the acoustic wave delivered within the region of the substrate surface is delivered to the fluid suspension in the channel through the pillar.

34. (canceled)
